(19) United States
(12) Patent Application Publication
(10) Pub. No.: US 2024/0275235 A1
(43) Pub. Date: Aug. 15, 2024

(54) FLYWHEEL SYSTEMS AND METHODS

(71) Applicant: PHOS GLOBAL ENERGY SOLUTIONS, INC., Frort Lauderdale, FL (US)

(72) Inventors: Victor Bica, Saint James, NY (US); Eugene Earle Rudolph, Port Jefferson Station, NY (US)

(21) Appl. No.: 18/289,706

(22) PCT Filed: May 13, 2022
(86) PCT No.: PCT/US2022/029255

§ 371 Date: Nov. 6, 2023

Related U.S. Application Data
(60) Provisional application No. 63/188,362, filed on May 13, 2021.

(51) Int. Cl. H02K 7/02; H02J 3/30; H02K 53/00

(52) U.S. Cl. CPC H02K 7/025; H02J 3/30; H02K 53/00; H02J 2300/24

(57) ABSTRACT

A renewable energy generation system, including a first flywheel, a second flywheel operably coupled to the first flywheel, a drive motor operably coupled to the first flywheel, wherein operation of the drive motor effectuates rotation of the first flywheel, wherein rotation of the first flywheel effectuates rotation of the second flywheel, and a generator operably coupled to the second flywheel, wherein the rotation of the second flywheel causes the generator to generate electrical energy.

### CROSS-REFERENCE TO RELATED APPLICATION

The present disclosure claims the benefit of and priority to U.S. Provisional Patent Application Ser. No. 63/188,362, filed on May 13, 2021, the entire content of which is hereby incorporated by reference herein.

### TECHNICAL FIELD

The present disclosure relates generally to renewable energy devices, and in particular, flywheel systems and methods for mechanical renewable energy generation and storage.

### BACKGROUND

Renewable energy generation, or green energy generation, has become an increasingly important source of electrical energy generation many countries around the world. As the demand for electrical energy has increased, the availability of fossil fuels has been strained, and the impact of using fossil fuels on the environment has been highlights. In an effort to overcome these obstacles, advancements in green energy generation have continued to accelerate, resulting in innovations such as hydrodynamic generators, wind turbines, geothermal energy, biomass energy, amongst others. However, mechanical energy generation, despite its simplicity, has historically remained rather inefficient. In particular, as a load is placed upon the system, the mechanical device driving electrical generators loses momentum, resulting in a drop in electrical energy generation. To avoid this decrease in electrical energy generation, it is necessary to input additional energy to maintain consistency and therefore, provide consistent electrical energy generation. As can be appreciated, the constant increase or decrease in energy required to maintain constant electrical energy generation using the mechanical device is inefficient and wasteful.

### SUMMARY

The present disclosure relates to a renewable energy generation system including a first flywheel, a second flywheel operably coupled to the first flywheel, a drive motor operably coupled to the first flywheel, wherein operation of the drive motor effectuates rotation of the first flywheel, wherein rotation of the first flywheel effectuates rotation of the second flywheel, and a generator operably coupled to the second flywheel, wherein the rotation of the second flywheel causes the generator to generate electrical energy.

In aspects, the rotation of the first flywheel may correspond to a first stored mechanical energy and rotation of the second flywheel may correspond to a second stored mechanical energy.

In certain aspects, the first and second flywheels may be operably coupled to one another to transfer the second stored mechanical energy of the second flywheel to the first flywheel.

In other aspects, the renewable energy generation system may include a gearbox assembly operably coupled to each of the first flywheel, the second flywheel, the drive motor, and the generator.

In certain aspects, the drive motor may be configured to be selectively decoupled from the gearbox assembly.

In aspects, the gearbox assembly may include a gear ratio permitting operation of the generator at a different rotational speed than a rotational speed of the first flywheel and a rotational speed of the second flywheel.

In other aspects, the gearbox assembly may include a drive gear operably coupled to the drive motor, a first driven gear operably coupled to the first flywheel, a second driven gear operably coupled to the second flywheel, and a generator gear operably coupled to the generator.

In certain aspects, the drive gear may be configured to be selectively magnetically coupled and selectively magnetically decoupled from the gearbox assembly.

In aspects, the renewable energy generation system may include a lifting mechanism operably coupled to the drive motor, wherein actuation of the lifting mechanism effectuates movement of the drive motor to magnetically decouple the drive gear from the first driven gear.

In accordance with another aspect of the present disclosure, a renewable energy generation system includes a magnetic gearbox assembly, including a drive gear, a first driven gear magnetically coupled to the drive gear, a second driven gear magnetically coupled to the first driven gear, and a generator gear magnetically coupled to the second driven gear, a drive motor operably coupled to the drive gear, a first flywheel operably coupled to the first driven gear, and a second flywheel operably coupled to the second driven gear, wherein rotation of the drive gear effectuates rotation of the first driven gear, wherein rotation of the first driven gear effectuates rotation of the second driven gear, and wherein rotation of the second driven gear effectuates rotation of the generator gear.

In aspects, the drive motor may be selectively decouplable from the magnetic gearbox.

In certain aspects, the renewable energy generation system may include a lifting mechanism operably coupled to the drive motor, wherein actuation of the lifting mechanism effectuates movement of the drive motor to magnetically decouple the drive gear form the first driven gear.

In other aspects, the renewable energy generation system may include a pair of contactless bearings operably coupled to a portion of the first flywheel, the pair of contactless bearings configured to suspend the flywheel and inhibit vertical and radial movement of the flywheel while permitting rotational movement of the flywheel.

In certain aspects, each contactless bearing of the pair of contactless bearings may include a plurality of magnetic elements, the plurality of magnetic elements defining concentric rings of alternating polarity extending radially outward from a center portion of each respective contactless bearing.

In accordance with another aspect of the present disclosure, a renewable energy generation system includes a first flywheel, a second flywheel operably coupled to the first flywheel, a generator configured to selectively engage and selectively disengage the first flywheel, and an energy storage device in electrical communication with the generator, the energy storage device configured to supply electrical energy to the generator when the generator is disengaged from the first flywheel.

In aspects, the energy storage device may be a supercapacitor.

In certain aspects, the renewable energy generation system may include a lifting mechanism operably coupled to the generator, wherein actuation of the lifting mechanism effectuates movement of the generator to disengage the generator from the first flywheel.

In other aspects, the renewable energy generation system may include a gearbox assembly, the gearbox assembly including a plurality of magnetic gears magnetically coupled to each of the first flywheel, the second flywheel, and the generator.

In aspects, the generator may be configured to be selectively magnetically coupled to the first flywheel and selectively magnetically decoupled from the first flywheel.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a schematic view of a renewable energy generation system provided in accordance with the present disclosure;

FIG. 2 is a side, cross-sectional view of a flywheel assembly of the renewable energy generation system of FIG. 1;

FIG. 3 is a side, cross-sectional view of a flywheel system of the renewable energy generation system of FIG. 1;

FIG. 4 is a side view of a portion of a gearbox assembly of the flywheel system of FIG. 3;

FIG. 5A is a side, cross-sectional view of a flywheel assembly of the flywheel system of FIG. 3 illustrating a drive motor operably coupled to a flywheel;

FIG. 5B is a side, cross-sectional view of a flywheel assembly of the flywheel system of FIG. 3 illustrating a drive motor decoupled from a flywheel;

FIG. 6 is a graph of an efficiency curve for a drive motor of the flywheel system of FIG. 3 provided in accordance with the present disclosure;

FIG. 7 is a side, cross-sectional view of a flywheel assembly of FIG. 2 illustrating a contactless bearing assembly provided in accordance with the present disclosure; and

FIG. 8 is a top view of a contactless bearing of the contactless bearing assembly of FIG. 7.

### DETAILED DESCRIPTION

The present disclosure is directed to a renewable energy generation system including flywheels for use as a mechanical storage device to meet peak demands or loss of power supplied by the power grid. The renewable energy generation system includes an electrical circuit interconnecting a solar array, a battery bank, a flywheel assembly, and a generator. The flywheel assembly includes a flywheel rotatably supported within a flywheel housing such that rotation, and therefore, the rotational inertia of the flywheel, store mechanical energy. The flywheel is operably coupled to a drive motor or motor/generator that is configured to spin the flywheel to a predetermined rotation speed or revolutions per minute (RPM) to store mechanical energy. The renewable energy generation system identifies when the power supplied to the power grid is insufficient to meet demands, or when the power supplied to the power grid has been interrupted. At this time, the renewable energy generation system operates the motor/generator to draw mechanical energy from the flywheel and generate electrical energy. In this manner, the renewable energy generation system utilizes the flywheel assembly as an uninterrupted power supply (UPS) to automatically transfer electrical energy from the motor/generator to the power grid.

The flywheel system of the renewable energy generation system includes a gear assembly having a drive gear operably coupled to the drive motor, a first driven gear operably coupled to a first flywheel and the drive gear, a second driven gear operably coupled to a second flywheel and the first driven gear, and a generator gear operably coupled to the generator and the second driven gear. Each of the gears within the gear assembly is a magnetic gear having an array of magnetic elements disposed thereon in alternating polarity about a circumference thereof (e.g., north, south, north, south, etc.). In this manner, operation of the drive motor effectuates rotation of the drive gear, which in turn, effectuates rotation of the first driven gear, which in turn effectuates rotation of the first flywheel. Further, rotation of the first driven gear effectuates rotation of the second driven gear, which in turn, effectuates rotation of the second flywheel. The rotation of the second driven gear effectuates rotation of the generator gear which causes operation of the generator and the generation of electrical energy.

In embodiments, the drive gear, and in embodiments, the generator gear, may be selectively decoupled from the gear assembly such that rotation of the first and second flywheels does not effectuate a corresponding rotation of the drive gear. As can be appreciated, decoupling the drive motor from the gear assembly, and therefore, the first and second flywheels, minimizes parasitic drag imparted on the first and second flywheels and maximizes the amount of energy stored by the first and second flywheels and the amount of time energy can be stored by the first and second flywheels. In embodiments, decoupling the drive motor and/or the generator from the gear assembly is effectuated by a lifting mechanism configured to lift the drive motor and/or generator away from the first and/or second flywheels. As can be appreciated, by coupling the first and second flywheels to one another via the gear assembly, the first and second flywheels are permitted to supplement one another and enable the use of only a single generator or a single drive motor, reducing complexity, drag placed upon the first and second flywheels, and the overall cost of the renewable energy generation system.

In embodiments, the renewable energy generation system includes an energy storage device, such as a supercapacitor, in electrical communication with the generator coupled to the first and second flywheels. As can be appreciated, movement of the generator to an operational position (e.g., magnetically coupled to the flywheel) may take a period of time (e.g., between approximately 3 to 12 seconds) after power is requested by the user. During this time period, the generator is unable to provide power, as the generator is not magnetically coupled to the flywheel. The supercapacitors supply electrical energy to the mains source during this time period to provide “power on demand” such that there is no delay in power received by the mains source after power is requested by the user. In this manner, the flywheel system is capable of utilizing only a single generator and/or drive motor, thereby reducing cost, complexity, and drag losses on the flywheel system. In embodiments, the supercapacitor may supply electrical energy to the generator during the transition from magnetically decoupled to magnetically coupled to the flywheel to spin-up or otherwise supply a load to the generator to reduce the impulse or step-function load applied to the generator when the flywheel becomes magnetically coupled to the generator, and in embodiments, the supercapacitor may be employed as a temporary or long-term storage of energy to assist in maintaining the speed of rotation of the flywheels.

In embodiments, the flywheel assemblies may include contactless bearings, having a plurality of concentric rings of magnetic elements disposed on a portion thereof. The concentric rings of magnetic elements are disposed in an alternating polarity in a direction radially extending from a center portion of the contactless bearing (e.g., north, south, north, south, etc.). A first contactless bearing is disposed on a portion of a stationary flywheel housing and a second contactless bearing is disposed on a portion of the flywheel in juxtaposed relation to the first contactless bearing such that the flywheel is suspended or otherwise axially maintained in position. As can be appreciated, the alternating polarities of the concentric rings of magnetic elements inhibits radial motion of the flywheel relative to the flywheel housing, reducing or eliminating the need for mechanical bearings to maintain the radial position of the flywheel. These and other aspects of the present disclosure will be described in further detail hereinbelow.

Embodiments of the present disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail. The present disclosure incorporates by reference the teachings of PCT/US2020/046453 entitled MECHANICAL RENEWABLE GREEN ENERGY PRODUCTION filed Aug. 14, 2020 and claiming priority to U.S. application Ser. No. 16/735,502 filed Jan. 6, 2020 and U.S. application Ser. No. 16/925,071 filed Jul. 9, 2020. All of these teachings of these prior applications are incorporated herein as if the complete disclosure were restated herein.

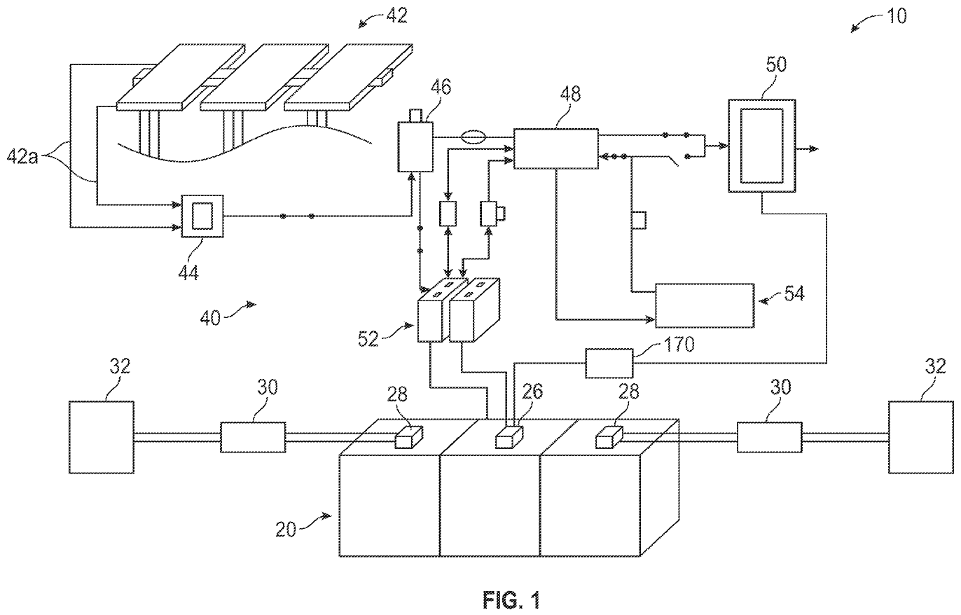

Turning now to the drawings, FIG. 1 illustrates a renewable energy system provided in accordance with the present disclosure and generally identified by reference numeral 10. The renewable energy system 10 includes a flywheel assembly 20 operably coupled to an electrical circuit 40, which is operably coupled to a solar array 42, a battery bank 52, and a generator 54.

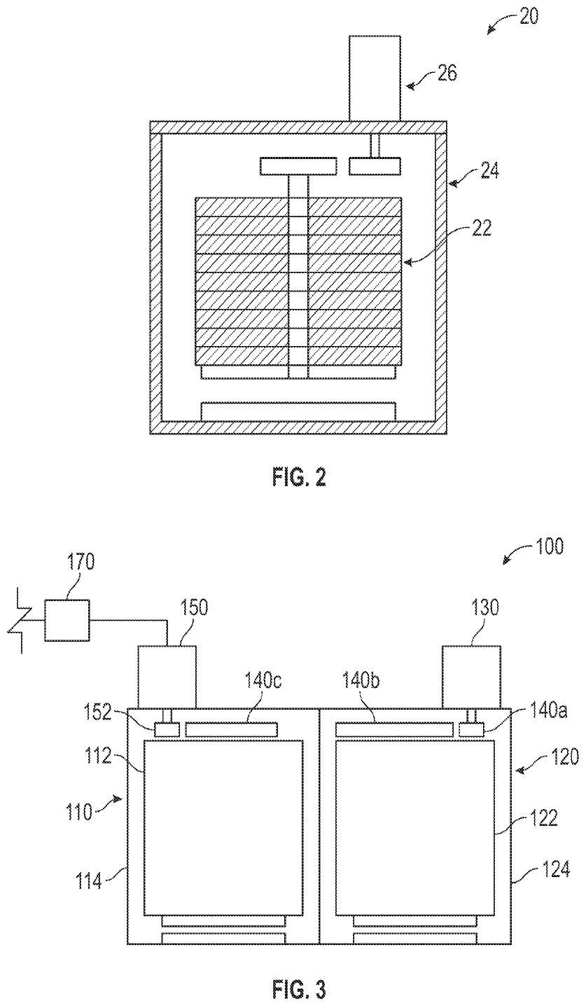

With additional reference to FIG. 2, the flywheel assembly 20 includes a flywheel 22 rotatably supported within a flywheel housing 24. The flywheel 22 is operably coupled to a motor-generator 26 disposed on a portion of the flywheel housing 24 such that rotation of the flywheel 22 effectuates a corresponding rotation of the motor-generator 26 and vice versa. It is envisioned that the motor-generator 26 may be any suitable type of motor and/or generator capable of converting electrical energy into rotational motion and vice versa, such as a DC motor, an AC motor, brushed motors, brushless motors, amongst others. In embodiments, it is envisioned that the flywheel assembly 20 may employ a stand-alone motor (not shown) to effectuate rotation of the flywheel 22 and a stand-alone generator (not shown) to generate electrical energy via the flywheel 22 effectuating rotation of a portion of the generator. Although generally described as having a single flywheel assembly 20, it is contemplated that the renewable energy system 10 may employ a plurality of flywheel assemblies 20, and in embodiments, the renewable energy system 10 utilizes three flywheel assemblies 20.

Continuing with FIG. 1, it is envisioned that the flywheel assembly 20 may be utilized as an uninterrupted power supply (UPS), such that if electrical power supplied by a component other than the flywheel assembly 20 is interrupted, energy generated by the flywheel assembly 20 can be automatically transferred to the electrical circuit 40, and thereby the loads connected thereto. In embodiments, a stand-alone generator is utilized as a UPS 28, which is operably coupled to an inverter 30 to convert the DC electrical energy generated by the UPS 28 to AC electrical energy having a certain voltage (e.g., 120v, 240v, etc.) and phase (e.g., single-phase, three-phase), which in turn, is operably coupled to a breaker panel 32, housing various electrical circuit breakers (not shown) that can be coupled to various loads and/or the electrical circuit 40. In embodiments, the UPS 28 outputs three-phase DC electrical energy, although it is contemplated that the UPS 28 may output single phase DC electrical energy, single phase AC electrical energy, three-phase AC electrical energy, etc., depending upon the design needs of the renewable energy system 10.

As can be appreciated, the flywheel assembly 20 may include sensing circuitry (not shown) to automatically detect when a load connected to the electrical circuit 40 is no longer being supplied with electrical energy (e.g., via mains power from the utility grid), and automatically transfer, via an automatic transfer switch or the like, the load to the breaker panel 32 and UPS 28 coupled to the flywheel assembly 20. In this manner, loads, such as hospital loads, hotel loads, residential loads, commercial loads, etc. such as lighting, equipment, amongst others, can operate continuously even if the traditional electrical energy source is lost. As can be appreciated, the loss of electrical energy may be transitory, at which time the automatic transfer switch operates in a reverse fashion and returns the supply of electrical energy to the mains source at which time the UPS 28 is no longer supplying electrical energy to the loads.

Continuing with FIG. 1, the solar array 42 is electrically coupled to the electrical circuit 40 via an electrical or combiner box 44. Various electrical wires 42a interconnect the solar array 42 and the combiner box 44, in which the electrical wires 42a are combined or otherwise reduced via breakers, fuses, couplings, amongst others (not shown). The combiner box 44 is electrically coupled to a charge controller 46 which in turn, is electrically coupled to the battery bank 52 and a solar array inverter 48. It is envisioned that the charge controller 46 may be any suitable charger controller that is capable of managing the transfer of electrical energy generated by the solar array 42 to the battery bank 52 to optimize charging of the battery bank 52 and avoiding overcharging, overheating, or otherwise damaging the battery bank 52. The solar array inverter 48 converts the DC electrical energy generated by the solar array 42 to AC electrical energy that can be utilized by various AC electrical energy loads coupled to the electrical circuit 40. In this manner, the solar array inverter 48 is electrically coupled to a service box or main breaker panel 50, which in turn, is electrically coupled to the various loads described hereinabove.

Continuing with FIG. 1, the generator 54 is electrically coupled to the solar array inverter 48 such that electrical energy can be supplied to the generator 54 via the solar array inverter 48 such that the generator 54 may identify when a voltage level for the battery bank 52 is low or otherwise depleted and cause the generator 54 to start or otherwise begin to supply electrical energy to the solar array inverter 48 to charge the battery bank 52 and/or supply electrical energy to the main breaker panel 50 and thereby the loads connected thereto. It is envisioned that the electrical circuit 40 may include an inverter bypass switch 46 interposed between the solar array inverter 48 and the main breaker panel 50 such that the electrical energy supplied to the main breaker panel 50 can be selected from the solar array inverter 48 or the generator 54. It is envisioned that the generator 54 may be any suitable generator such as a gasoline generator, a diesel generator, a natural gas generator, a hydrogen fueled generator, amongst others.

During operation, it is envisioned that the electrical energy generated by the solar array 42 may be utilized to maintain or otherwise bring the flywheels 22 of the flywheel assembly 20 to maximum revolutions per minute (RPM) by supplying electrical energy to the motor-generator 26 or stand-alone motor. As can be appreciated, the mass of the flywheel 22, and therefore the inertia of the mass, once spinning, requires considerably less energy to maintain the flywheel 22 spinning as compared to bringing a stationary flywheel 22 up to maximum RPM. Therefore, as electrical energy is drawn from the flywheel 22 via the UPS 28 and inverted for supply to the main breaker panel 50, the flywheel 22 loses energy, and therefore, its RPM is reduced. In this manner, the electrical energy generated by the solar array 42 may be utilized to maintain the RPM of the flywheel 22 to supply sufficient electrical energy to the loads that the solar array 42 can supply on its own.

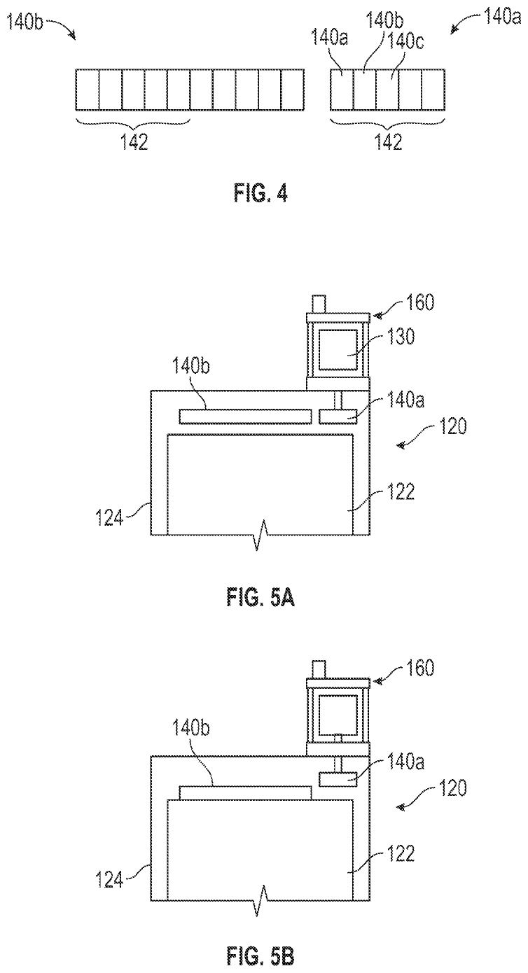

With reference to FIGS. 3-5B, a flywheel system is illustrated and generally identified by reference numeral 100. The flywheel system 100 includes at least two flywheel assemblies 110 and 120, respectively, a single drive motor 130, a gear assembly 140 including a plurality of magnetic gears operably coupled to each of the at least two flywheel assemblies 110, 120 and the drive motor 130, and a generator 150 operably coupled to one or more gears of the plurality of magnetic gears 140, as will be described in further detail hereinbelow.

Each flywheel assembly 110, 120 includes a respective flywheel 112 and 122 rotatably disposed within a flywheel housing 114 and 124, respectively. The drive motor 130 is supported on one of the flywheel housings 114, 124 of the flywheel assemblies 110, 120 using any suitable means, such as fasteners, adhesives, welding, amongst others. In one non-limiting embodiment, the drive motor 130 is supported on the flywheel housing 124. The drive motor 130 is operably coupled to a first drive gear 140a of the plurality of magnetic gears 140 such that the drive motor 130 effectuates rotation of the first drive gear 140a in a first direction. The first drive gear 140a is magnetically coupled to a first driven gear 140b operably coupled to a portion of the flywheel 122 of the flywheel assembly 120 such that rotation of the first drive gear 140a effectuates a corresponding rotation of the first driven gear 140b, and therefore, rotation of the flywheel 122 within the flywheel housing 124. The outer dimensions of the first drive gear 140a and the first driven gear 140b differ such that the first drive gear 140a and the first driven gear 140b rotate at different speeds (e.g., different RPM's), thereby enabling the drive motor 130 to operate at it's most efficient RPM and enabling the flywheel 122 to rotate at its most efficient RPM, which may be different than the RPM at which the drive motor 130 is most efficient. As can be appreciated, the gear ratio (e.g., the outer dimensions) of the first drive gear 140a and the first driven gear 140b may be altered depending upon the design needs of the flywheel system 100.

The first drive gear 140a and the first driven gear 140b each include a plurality of magnetic elements 142 disposed on an outer circumference thereof in a circumferential manner. The plurality of magnetic elements 142 is disposed in an alternating fashion, e.g., a pole of each respective magnetic element of the plurality of magnetic elements 142 alternates in a north, south, north, south, etc. fashion. In this manner, a first magnetic element 142a is disposed on the outer circumference of the first drive gear 140a with its north pole facing outwards (e.g., away from a center portion of the first drive gear 140a) and a second, adjacent magnetic element 142b is disposed on the outer circumference of the first drive gear 140a with its south pole facing outwards (e.g., away from a center portion of the first drive gear 140a). As can be appreciated, the alternating polarity of the magnetic elements 142 enables the first drive gear 140a to magnetically couple to the first driven gear 140b such that rotation of the first drive gear 140a effectuates a corresponding rotation of the first driven gear 140b.

Continuing with FIGS. 3-5B, the flywheel assembly 110 includes a second driven gear 140c operably coupled to the flywheel 112 such that rotation of the second driven gear 140c effectuates a corresponding rotation of the flywheel 112 and vice versa. The second driven gear 140c is magnetically coupled to the first driven gear 140b such that rotation of the first driven gear 140b effectuates rotation of the second driven gear 140c, and thereby a corresponding rotation of the flywheel 112, and vice versa. It is envisioned that the first driven gear 140b and the second driven gear 140c may include the same or different outer dimension depending upon the design needs of the flywheel system 100. The second driven gear 140c includes a plurality of magnetic elements 142 disposed therein in a substantially similar manner as described herein above with respect to the first drive gear 140a and the first driven gear 140b.

Although generally described has having two flywheel assemblies 110, 120 and a single drive motor 130 operably coupled thereto, it is envisioned that the flywheel system 100 may include any suitable number of flywheel assemblies (e.g., three, four, five, six, etc.) driven by the single drive motor 130 or may utilize multiple drive motors 130 (e.g., two, three, four, five, six, etc.) to drive any suitable number of flywheel assemblies. Although generally illustrated as being disposed adjacent one another at the generally same height (e.g., horizontally), it is envisioned that the flywheel assemblies may be disposed above or below one another (e.g., vertically), depending upon the design needs of the flywheel system 100. It is envisioned that the drive motor 130 may be any suitable type of motor capable of converting electrical energy into rotational motion, such as a DC motor, an AC motor, brushed motors, brushless motors, amongst others.

With reference to FIG. 3, one or both of the flywheel assemblies 110, 120 include a generator 150 disposed thereon that is operably coupled to one or both of the flywheels 112, 122. In one non-limiting embodiment, the generator 150 is disposed on the flywheel housing 114 and is includes a generator gear 152 operably coupled thereto such that rotation of the generator gear 152 causes the generator 150 to generate electrical energy. The generator gear 152 is magnetically coupled to the second driven gear 140c such that rotation of the flywheel 112 effectuates rotation of the second driven gear 140c, which in turn, effectuates a corresponding rotation of the generator gear 152 such that the generator 150 generates electrical energy. In this manner, the kinetic energy stored by the flywheels 112, 122 is transmitted to the generator gear 152 to enable the generator 150 to convert the kinetic energy stored by the flywheels 112, 122 to electrical energy. It is envisioned that the flywheel assemblies 110, 120 may include a plurality of magnetic elements (not shown) disposed on a portion thereof in a similar fashion as described hereinabove with respect to the first drive gear 140a and first driven gear 140b, to enable rotation of the flywheel assemblies 110, 120 to effectuate a corresponding rotation of the second driven gear 140c and vice versa.

With reference to FIGS. 5A and 5B, it is envisioned that when the flywheel system 100 is drawing kinetic energy from the flywheels 112, 122 to generate electrical energy that the first drive gear 140a coupled to the drive motor 130 may be magnetically decoupled from the first driven gear 140b. In this manner, the mechanical and magnetic drag caused by operation of the motor 130 (even when not being electrically energized) is not imparted on the flywheels 112, 122 thereby increasing the amount of kinetic energy that can be drawn from the flywheels 112, 122 and increasing overall efficiency of the flywheel system 100. It is envisioned that the first drive gear 140a may be decoupled from the first driven gear 140b using any suitable means, such as moving the first drive gear 140a away from the first driven gear 140b such that the magnetic fields of the first drive gear 140a and first driven gear 140b no longer interact (e.g., the flux between the first drive gear 140a and the first driven gear 140b is below a threshold that enables rotation of the first drive gear 140a to cause rotation of the first driven gear 140b and vice versa). In embodiments, the first drive gear 140a may be entirely magnetically decoupled from the first driven gear 140b such that the magnetic fields do not interact and impart drag upon the flywheel system 100. Although generally described as being applied to the drive motor 130, it is envisioned that the same principle may be applied to the generator 150 to minimize the drag imparted by operation of the generator 150 when the drive motor 130 is spinning up or otherwise increasing the rotational speed of the flywheels 112, 122 (e.g., utilize less electrical power to bring the rotational speed of the flywheels 112, 122 to maximum RPM).

In embodiments, the drive motor 130 is operably coupled to a lifting mechanism 160 that is operably coupled to a portion of the flywheel housing 124. In this manner, operation of the lifting mechanism 160 in a first direction causes the drive motor 130 to be lifted away (e.g., vertically moved) from the flywheel 122. In embodiments, the lifting mechanism 160 may be a leadscrew and motor assembly, a linear actuator, a scissor lift, amongst others. Although generally described as being vertically lifted, it is envisioned that the lifting mechanism 160 may cause the drive motor 130 to follow an arc or other suitable curvature (e.g., hinged arrangement). In one non-limiting embodiment, the lifting mechanism 160 utilizes a flexure beam (not shown) to inhibit backlash and frictional losses, although it is contemplated that the drive motor 130 may be coupled to a rigid beam hingedly coupled to a portion of the flywheel housing 124 via bull pins, bushings, bearings, amongst others. In embodiments, the lifting mechanism 160 may utilize a 4-bar linkage type mechanism or a flexure mechanism to reduce the energy required to move the drive motor 130 and reduce wear on the lifting mechanism 160. It is envisioned that the lifting mechanism 160 may include bushings, isolators, or other suitable devices capable of reducing vibrations between the drive motor 160 and the flywheel housing 124.

In embodiments, the drive motor 130 may be locked into a first, operating position, where the first drive gear 140a is magnetically coupled to the first driven gear 140b, and locked into a second, inoperable position, where the first drive gear 140a is magnetically decoupled to the first driven gear 140b via electro-magnets, permanent magnets, detents, catches, amongst others. In one non-limiting embodiment, the lifting mechanism 160 lifts the drive motor 130 a distance of about 2 to 3 inches, although it is contemplated that the lifting mechanism 160 may lift the drive motor 130 any suitable distance depending upon the design needs of the flywheel system 100.

Returning to FIG. 3, it is envisioned that the flywheel system 100 may include one or more capacitors 170 electrically coupled to the generator 150 and to the mains source of the renewable energy system 10. It is envisioned that the one or more capacitors 170 may be any suitable capacitor capable of meeting the energy demands of the flywheel system 100 and/or the renewable energy system 10, and in one non-limiting embodiment, may be a super capacitor or a bank of supercapacitors. It is envisioned that the in lieu of the one or more capacitors 170, the flywheel system 100 may employ one or more batteries.

As can be appreciated, movement of the generator 150 by the lifting mechanism 160 into an operational position (e.g., magnetically coupled to the flywheel 122) may take a period of time (e.g., between approximately 3 to 12 seconds) after power is requested by the user. During this time period, the generator 150 is unable to provide power, as the generator 150 is not magnetically coupled to the flywheel 122. The one or more capacitors 170 supply electrical energy to the mains source during this time period to provide “power on demand” such that there is no delay in power received by the mains source after power is requested by the user. In this manner, the flywheel system 100 is capable of utilizing only a single generator 150 and/or motor 130, thereby reducing cost, complexity, and drag losses on the flywheel system 100. In embodiments, the one or more capacitors 170 may supply electrical energy to the generator during the transition from magnetically decoupled to magnetically coupled to the flywheel 122 to spin-up or otherwise supply a load to the generator 150 to reduce the impulse or step-function load applied to the generator 150 when the flywheel 122 becomes magnetically coupled to the generator 150. In this manner, the reduction in step-up load on the generator 150 minimizes slipping of the magnetic elements 142 and effectuates a smoother transition between the magnetically uncoupled and magnetically coupled positions of the generator 150. In embodiments, the one or more capacitors 170 may be employed as a temporary or long-term storage of energy to assist in maintaining the speed of rotation of the flywheels 122, and in embodiments, may be employed to generate hydrogen.

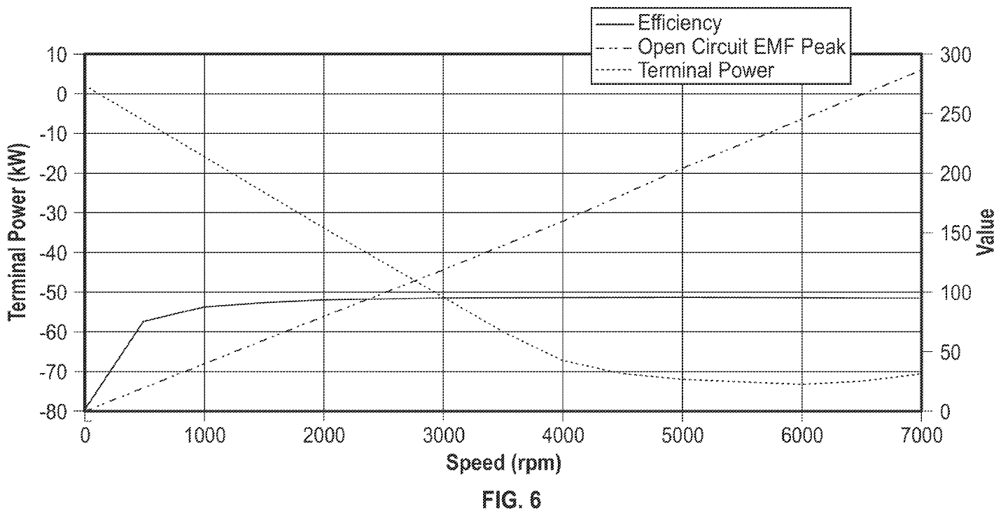

With reference to FIG. 6, an example of the power and voltage characteristics of the generator 150 when used in a power generation mode. It is envisioned that the generator 150 may be any suitable sized generator, and in embodiments, the generator 150 is a 130 KW motor capable of generating up to 70 KW when in power generation mode. It is envisioned that the generator 150 may be coupled to the flywheel 122 using any suitable gear ratio, such as 1:1, 2:1, 1:2, etc. and in one non-limiting embodiment, the generator 150 is coupled to the flywheel 122 using an approximately 3:1 gear ration such that as the flywheel 122 is rotating at 10,000 RPM, the generator 150 has an operation range of approximately between 2,000-3,500 RPM.

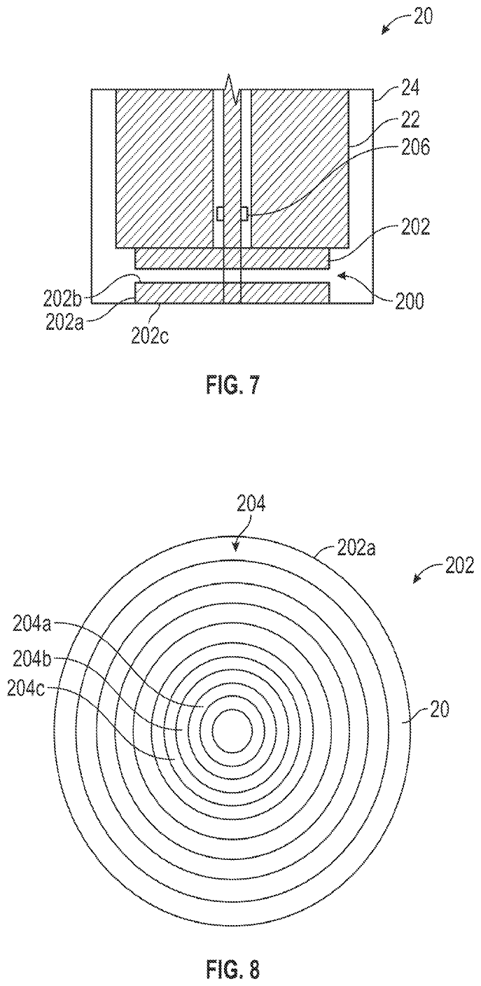

Turning now to FIGS. 7 and 8, a contactless bearing assembly is illustrated and generally identified by reference numeral 200. The contactless bearing assembly 200 includes a pair of contactless bearings 202 disposed in juxtaposed relation to one another and are substantially similar to one another. Therefore, only one contactless bearing of the pair of contactless bearings 202 will be described in detail herein in the interest of brevity.

The contactless bearing 202 includes a generally circular profile having an outer surface 202a extending between opposed top and bottom surfaces 202b and 202c, respectively. The contactless bearing 202 includes a plurality of magnetic elements 204 disposed on a portion of the top surface 202b. It is envisioned that the plurality of magnetic elements 204 may be coupled to the top surface 202b of the contactless bearing 202 via any suitable means, such as adhesives, fasteners, magnetic force (e.g., magnetic attraction between the magnetic elements and the material from which the contactless bearing 202 is formed), amongst others. The plurality of magnetic elements 204 form a plurality of concentric rings 204a, 204b, 204c, etc. disposed in a nested configuration extending from a center portion of the contactless bearing 202 towards the outer surface 202a. Each of the concentric rings 204a, 204b, 204c, etc. is disposed on the top surface 202b of the contactless bearing such that the polarity of each of the concentric rings 204a, 204b, 204c, etc. facing away from the top surface 202b of the contactless bearing 202 alternates (e.g., concentric ring 204a is north, concentric ring 204b is south, concentric ring 204c is north, etc.). Although generally described as being disposed on the top surface 202b, it is envisioned that the plurality of magnetic elements 204 may be disposed in corresponding recesses or grooves (not shown) and may be formed from one or more individual magnetic elements (e.g., one large continuous magnetic element, two magnetic elements, etc.). It is envisioned that the use of circular discs or ring magnets in attraction with a designed gap to radially centralized the rotating mass. Further, multiple concentric disc/rings mirrored pairs or fields with magnetic attraction fields concentric to a magnetic repulsion fields can be employed.

Continuing with FIGS. 7 and 8, as described hereinabove, the pair of contactless bearings 202 is disposed in juxtaposed relationship to one another. In this manner, a first contactless bearing 202 is disposed on a portion of the flywheel 22 and a second contactless bearing 202 is disposed on a portion of the flywheel housing 24 adjacent or otherwise axially aligned with the first bearing 202 disposed on the flywheel 22. The pair of contactless bearings 202 is disposed generally axially aligned with one another such that the plurality of concentric rings 204 generally align with one another such that the pair of contactless bearings 202 is magnetically opposed to one another (e.g., the concentric ring 204a of the first contactless bearings 202 is aligned with the concentric ring 204a of the second contactless bearing). In this manner, the pair of contactless bearings 202 suspend or otherwise maintain the flywheel 22 vertical distance away from the flywheel housing 24. The alternating polarity of the concentric rings 204a, 204b, 204c, etc. cooperate to maintain axial alignment of the pair of contactless bearings 202 and inhibit radial movement of the contactless bearings 202 relative to one another. In this manner, the pair of contactless bearings 202 cooperate to maintain a position (both vertical and horizontal) of the flywheel 22 relative to the flywheel housing 24 without the use of mechanical bearings (e.g., radial bearings, thrust bearings, amongst others).

Although generally described as not having mechanical bearings, it is envisioned that the flywheel assembly 20 may utilize safety or mechanical bearings 206 that are undersized or otherwise configured to remain free from contact with a portion of the flywheel 22 during normal operation and contact or otherwise abut a portion of the flywheel 22 if the flywheel 22 becomes misaligned or otherwise is urged in a radial direction to inhibit damage to the flywheel 22, the flywheel housing 24, amongst others. It is envisioned that an elastomeric/polymeric band (not shown) constraining an outer dimension of the mechanical bearing 206 in the radial direction to produce a radial vibration isolation and/or dampening bearing system for lower flywheel rotational speeds, such as during start-up of the flywheel 22. In embodiments, the contactless bearing 202 may be a magnetic bearing where the large rotating mass has a hard connection to an arrangement of magnetic elements that are attracted to (one or more separate arrangements of magnetic elements that are constrained by a separate mechanical or magnetic bearing) to provide radial stiffness to the large rotating mass).

The contactless bearing 200 may be formed from any suitable material, such as metallic materials such as aluminum, steel, stainless steel, tungsten, etc., and alloys and/or combinations thereof, non-metallic materials such as polymers, ceramics, composites, amongst others. In embodiments, the contactless bearing 200 may be formed entirely from a permanent magnet, such as a ceramic or ferrite magnet, a neodymium magnet, an alnico magnet, and injected molded magnet, a rare earth magnet, a magnetic metallic element, amongst others, although it is contemplated that the magnet may be an electromagnet.

It will be understood that various modifications may be made to the embodiments of the presently disclosed renewable energy generation systems. Therefore, the above description should not be construed as limiting, but merely as exemplifications of embodiments. Those skilled in the art will envision other modifications within the scope and spirit of the present disclosure.

What is claimed is:

1. A renewable energy generation system, comprising:
a first flywheel;
a second flywheel operably coupled to the first flywheel;
a drive motor operably coupled to the first flywheel, wherein operation of the drive motor effectuates rotation of the first flywheel, wherein rotation of the first flywheel effectuates rotation of the second flywheel; and
a generator operably coupled to the second flywheel, wherein the rotation of the second flywheel causes the generator to generate electrical energy.

2. The renewable energy generation system according to claim 1, wherein the rotation of the first flywheel corresponds to a first stored mechanical energy and rotation of the second flywheel corresponds to a second stored mechanical energy.

3. The renewable energy generation system according to claim 2, wherein the first and second flywheels are operably coupled to one another to transfer the second stored mechanical energy of the second flywheel to the first flywheel.

4. The renewable energy generation system according to claim 1, further comprising a gearbox assembly operably coupled to each of the first flywheel, the second flywheel, the drive motor, and the generator.

5. The renewable energy generation system according to claim 4, wherein the drive motor is configured to be selectively decoupled from the gearbox assembly.

6. The renewable energy generation system according to claim 5, wherein the gearbox assembly includes a gear ratio permitting operation of the generator at a different rotational speed than a rotational speed of the first flywheel and a rotational speed of the second flywheel.

7. The renewable energy generation system according to claim 5, wherein the gearbox assembly includes:
a drive gear operably coupled to the drive motor;
a first driven gear operably coupled to the first flywheel;
a second driven gear operably coupled to the second flywheel; and
a generator gear operably coupled to the generator.

8. The renewable energy generation system according to claim 7, wherein the drive gear is magnetically coupled to the first driven gear, the first driven gear is magnetically coupled to the second driven gear, and the second driven gear is magnetically coupled to the generator gear.

9. The renewable energy generation system according to claim 8, wherein the drive gear is configured to be selectively magnetically coupled and selectively magnetically decoupled from the gearbox assembly.

10. The renewable energy generation system according to claim 9, further comprising a lifting mechanism operably coupled to the drive motor, wherein actuation of the lifting mechanism effectuates movement of the drive motor to magnetically decouple the drive gear from the first driven gear.

11. A renewable energy generation system, comprising:
a magnetic gearbox assembly, including:
a drive gear;
a first driven gear magnetically coupled to the drive gear;
a second driven gear magnetically coupled to the first driven gear; and
a generator gear magnetically coupled to the second driven gear;
a drive motor operably coupled to the drive gear;
a first flywheel operably coupled to the first driven gear; and
a second flywheel operably coupled to the second driven gear, wherein rotation of the drive gear effectuates rotation of the first driven gear, wherein rotation of the first driven gear effectuates rotation of the second driven gear, and wherein rotation of the second driven gear effectuates rotation of the generator gear.

12. The renewable energy generation system according to claim 11, wherein the drive motor is selectively decouplable from the magnetic gearbox.

13. The renewable energy generation system according to claim 12, further comprising a lifting mechanism operably coupled to the drive motor, wherein actuation of the lifting mechanism effectuates movement of the drive motor to magnetically decouple the drive gear from the first driven gear.

14. The renewable energy generation system according to claim 11, further comprising a pair of contactless bearings operably coupled to a portion of the first flywheel, the pair of contactless bearings configured to suspend the flywheel and inhibit vertical and radial movement of the flywheel while permitting rotational movement of the flywheel.

15. The renewable energy generation system according to claim 14, wherein each contactless bearing of the pair of contactless bearings includes a plurality of magnetic elements, the plurality of magnetic elements defining concentric rings of alternating polarity extending radially outward from a center portion of each respective contactless bearing.

16. A renewable energy generation system, comprising:
a first flywheel;
a second flywheel operably coupled to the first flywheel;
a generator configured to selectively engage and selectively disengage the first flywheel; and
an energy storage device in electrical communication with the generator, the energy storage device configured to supply electrical energy to the generator when the generator is disengaged from the first flywheel.

17. The renewable energy generation system according to claim 16, wherein the energy storage device is a supercapacitor.

18. The renewable energy generation system according to claim 16, further comprising a lifting mechanism operably coupled to the generator, wherein actuation of the lifting mechanism effectuates movement of the generator to disengage the generator from the first flywheel.

19. The renewable energy generation system according to claim 16, further comprising a gearbox assembly, the gearbox assembly including a plurality of magnetic gears magnetically coupled to each of the first flywheel, the second flywheel, and the generator.

20. The renewable energy generation system according to claim 19, wherein the generator is configured to be selectively magnetically coupled to the first flywheel and selectively magnetically decoupled from the first flywheel.
